(19) United States
(12) Patent Application Publication
(10) Pub. No.: US 2015/0178455 A1
(43) Pub. Date: Jun. 25, 2015

(54) Method and system for collecting medication adherence data

(71) Applicant: DARO BRYON GROSS, MONTE SERENO, CA (US)

(72) Inventor: DARO BRYON GROSS, MONTE SERENO, CA (US)

(73) Assignee: DARO BRYON GROSS, LOS GATOS, CA (US)

(21) Appl. No.: 14/121,189

(22) Filed: Aug. 11, 2014

Related U.S. Application Data
(60) Provisional application No. 61/964,085, filed on Dec. 23, 2013.

(51) Int. Cl. G06F 19/00; A61J 7/00

(52) U.S. Cl. CPC G06F 19/3418; A61J 7/0076

(57) ABSTRACT

This is a method and system by which medication adherence data may be remotely collected to generate metrics for measuring adherence to a medication therapy as well as the appropriateness of a prescribed medication therapy. This invention provides the user of the apparatus with a system for taking medications both at and away from the home where the apparatus is located. Operation of the apparatus is monitored over time and with local calculation over time of the pattern of use to permit displaying a visual representation thereof. This invention is suited to improving the operation of a medication adherence program targeted at persons with acute or chronic conditions.

### CROSS-REFERENCES TO RELATED APPLICATIONS

This application claims the benefit of U.S. Provisional Application No. 61/964,085, filed Dec. 23, 2013, the disclosure of which is incorporated herein by reference.

### FIELD

This invention relates to the field of healthcare information technology. More specifically, the invention provides for a method and system for collecting medication adherence data in order that it can be used as a metric to optimize medication therapy.

### BACKGROUND

Persons with chronic illnesses impose a large and disproportionate share of health care costs. Studies conducted in the U.S. have calculated that as much as 50 percent of the general population is afflicted with one or more chronic conditions, and these persons account for approximately 84 percent of health care costs. Participation in employee health and wellness programs has been demonstrated to reduce health care cost costs by 21 percent in large general populations with 78 percent of the saving attributable to disease management programs. And among disease management programs, medication therapy management has been found to be the single most cost-effective strategy for both improving outcomes and reducing costs.

Non-adherence to a medication therapy, as a metric, has been found to average 50 percent among patients with chronic conditions. While existing medication adherence solutions have been proven to be highly effective in helping small populations with acute illnesses to comply with prescribed medication therapies, they have not been found useful for addressing the more pressing problem of managing medication therapy in large populations with chronic conditions.

### RELATED ART

The prior art describes methods, systems, and devices to improve compliance to a prescribed medication therapy. High levels of compliance (>90 percent) to medication therapy accompanied by improved medical outcomes have resulted from the application of these inventions in populations with acute conditions. However, none of these inventions have been found useful in improving health outcomes in populations with chronic conditions.

Data collection methods employed by the prior art require timely access to medication dispensers located at a single location, usually the home, in order to collect data related to medication adherence. This restriction precludes targeting populations with chronic conditions that cannot remain in close proximity to a medication dispenser.

The prior art also teaches compliance to a medication therapy that may or may not be appropriate. While medication adherence has been proven to be a useful metric for optimizing medication therapy, medication adherence is not a goal in and of itself. The prior art seeks to improve adherence to a medication therapy instead of generating data supporting identifying an appropriate medication therapy.

The method of data collection by the prior art helps to predict deviation from a prescribed medication therapy, which also may or may not be an appropriate therapy. A properly designed data collection method must generate data that is useful in making decisions that maximize, not medication adherence, but a health outcome. The present invention fulfills these needs and provides further related advantages as described in the following summary.

### SUMMARY OF THE INVENTION

The present invention teaches certain benefits in design, methods, and systems that give rise to the objectives described below.

The data collection apparatus includes an electronics module that records when medication is dispensed and sends the data over a network, indicates status information about the apparatus, and supports connection to medication dispensing modules as described below.

The apparatus can be configured to include one or more medication dispensing modules to allow recording of multiple medication dosing events per day. A medication dispensing module includes seven individually detachable medication containers, one for each day of the week. Sensors record when the detachable medication containers are removed from a medication dispensing module.

To generate data that correlate between the use of the apparatus and an appropriate medical outcome, there are time indicators on each medication module that are configured to indicate when medication is scheduled to be taken, and a visual representation of the use of the medication dispensing module over time is displayed for each medication module.

A primary objective of the invention is to provide a method for collecting medication adherence data that provides advantages not taught by the prior art.

Another objective is to provide such an invention that provides for automated monitoring of a medication schedule that accommodates both local and remote proximity to a medication dispenser apparatus.

A further objective is to provide such an invention capable of storing and displaying data about the use of the apparatus over time.

Other features and advantages of the invention will become apparent from the following more detailed description, taken in conjunction with the accompanying drawings, which illustrate, by way of example, the principles of the invention.

### DESCRIPTION OF THE DRAWINGS

The accompanying drawings illustrate the invention. In such drawings:

FIG. 1 is a perspective view of an embodiment of the electronics module.

FIG. 2 is a perspective view of an embodiment of the dispenser module.

FIG. 3 is a perspective view of an embodiment of the controls and display on the dispenser module.

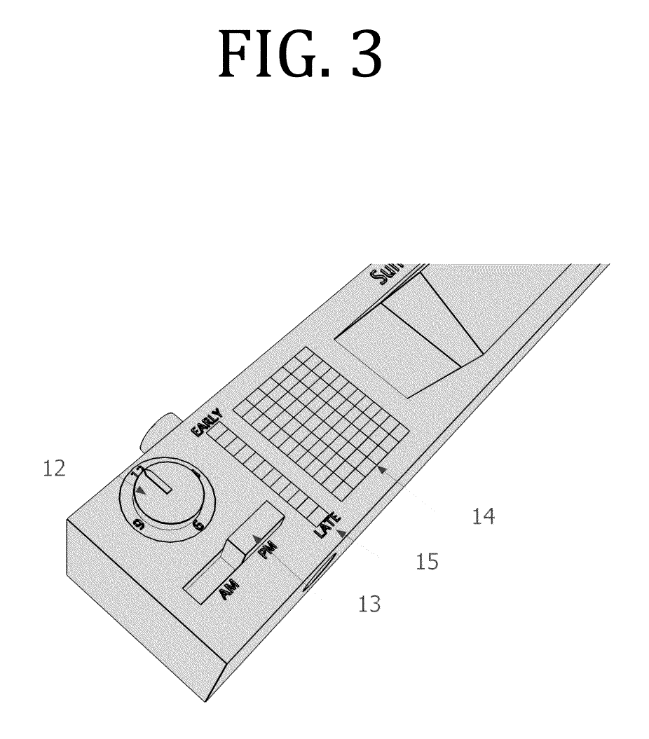

FIG. 4 is a perspective view of an embodiment of the data collection apparatus with one dispenser module.

FIG. 5 is a perspective view of an embodiment of the data collection apparatus with two dispenser modules.

FIG. 6 is a perspective view of an embodiment of the data collection apparatus with three dispenser modules.

FIG. 7 is a perspective view of an embodiment of the data collection apparatus with four dispenser modules.

FIG. 8 is a perspective view of an embodiment of the housing for an individually removable medication container.

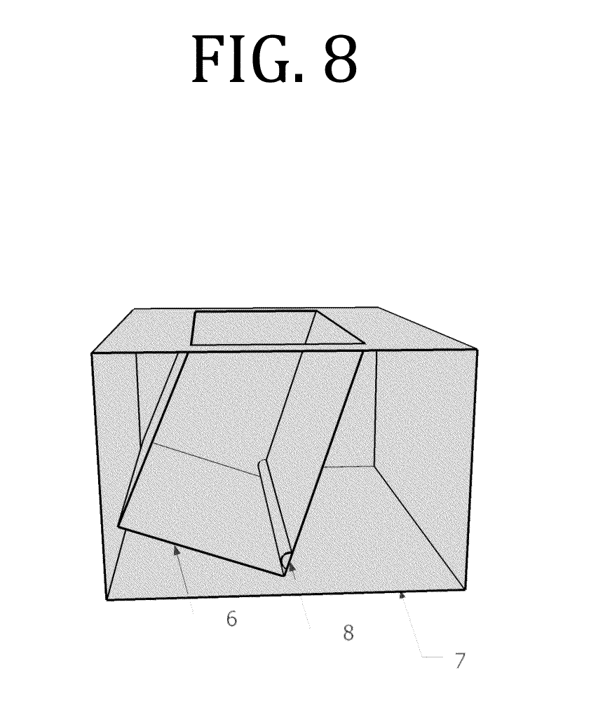

FIG. 9 is a perspective view of an embodiment of an individually removable medication container seated in a dispenser module with the lid open.

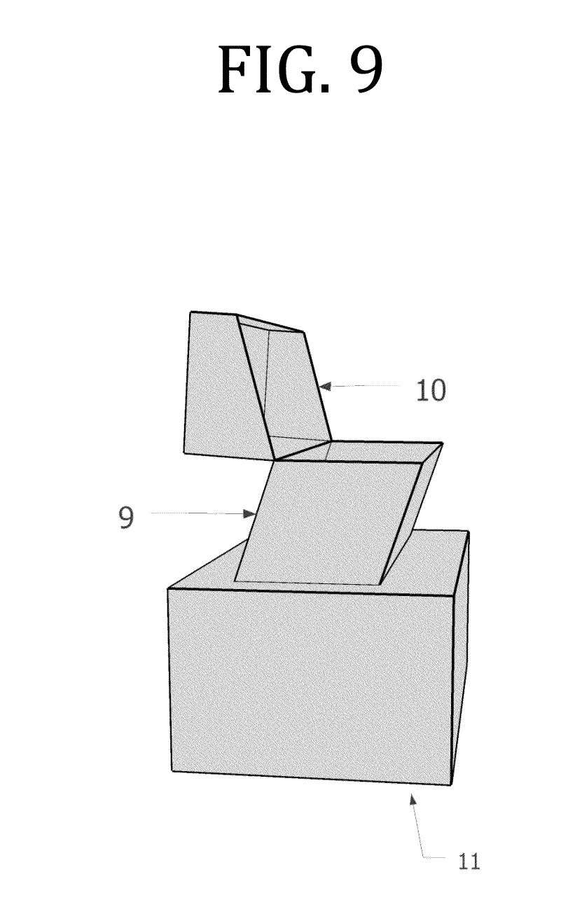

### DETAILED DESCRIPTION OF THE INVENTION

The above described drawing figures illustrate the invention in at least one of its preferred embodiments, which is further defined in detail in the following description.

The present invention is a method for collecting medication adherence data in order that the data can be used as a metric to determine adherence to a medication therapy and the appropriateness of a medication therapy. In the following description, for purposes of explanation, numerous specific details are set forth in order to provide a thorough understanding of example embodiments. It will be evident, however, to one of ordinary skill in the art that embodiments of the invention may be practiced without these specific details.

The methods and systems described are directed towards collecting data to improve medication adherence programs; in particular, medication adherence programs intended to be operated to serve large populations participating in employee wellness programs. The methods and systems may also be used within the context of other health care programs intended to improve medication therapy outcomes.

In general, the methods and systems may include means of identifying persons who are at risk of deviating from an appropriate medication therapy and the likelihood of having been prescribed an appropriate medication therapy. Specifically, the methods and systems pertain to measurements of compliance with patterns of use of a medication dispenser.

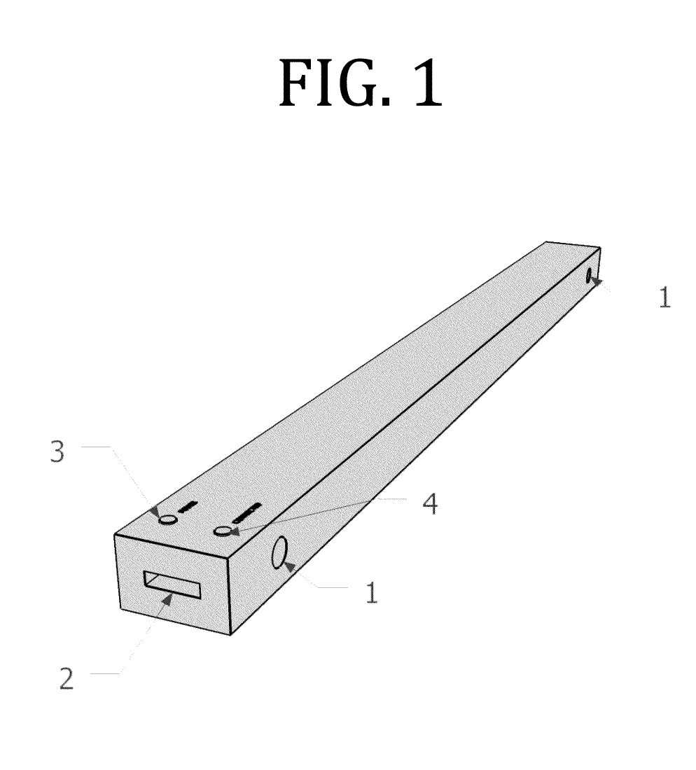

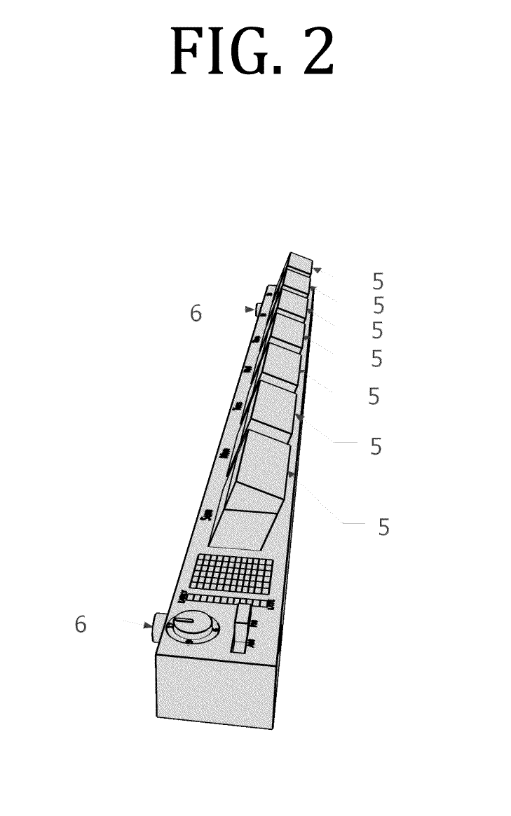

The preferred embodiment of the present invention includes a medication dispenser apparatus that is comprised an electronics module (FIG. 1) with one or more connectors (1) for attaching a medication dispensing module (FIG. 2), a connection to a power source such as the depicted female USB connector (2), a power indicator (3), and a network connection indicator (4).

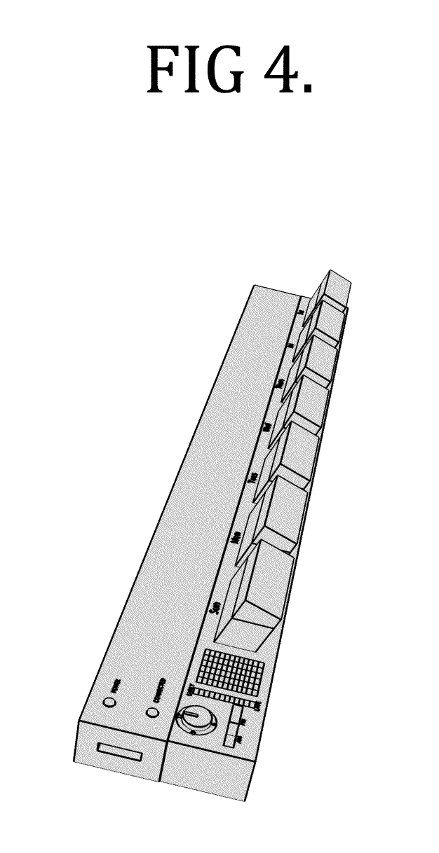

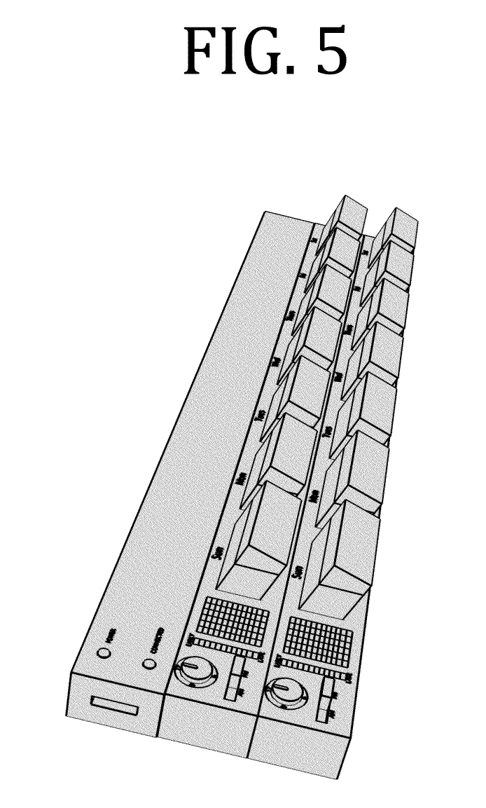

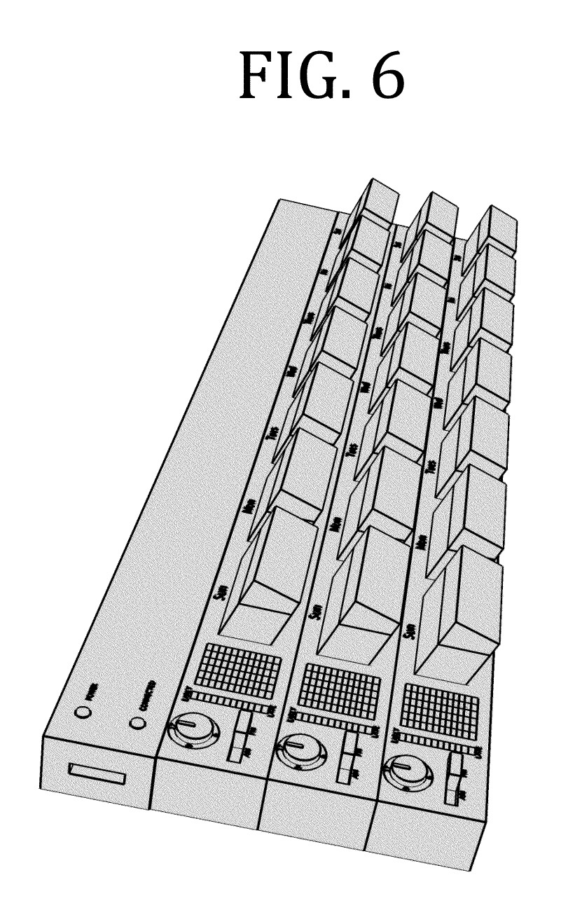

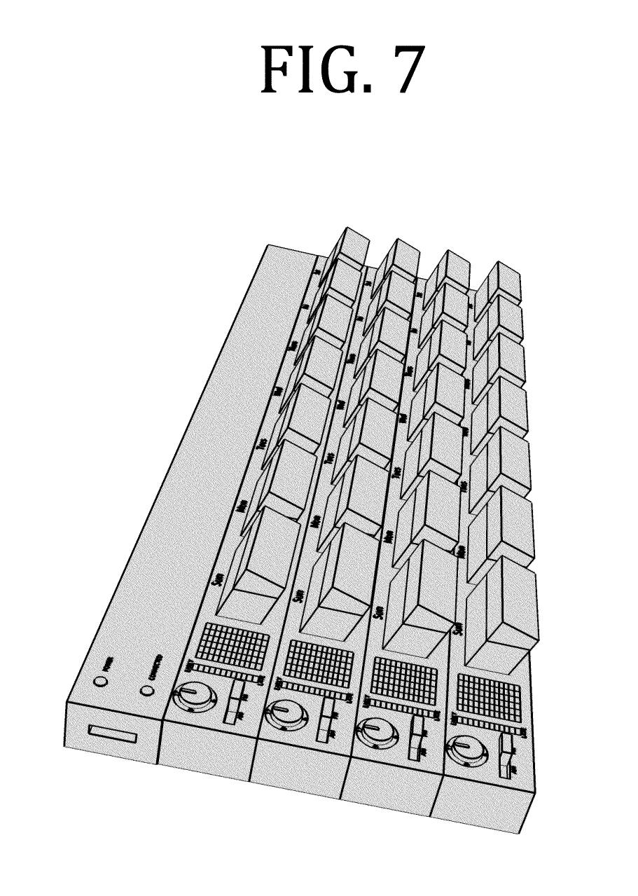

The preferred embodiment of the dispenser apparatus may be configured with one dispenser module (FIG. 4), two dispenser modules (FIG. 5), three dispenser modules (FIG. 6), or four dispenser modules (FIG. 7).

In the preferred embodiment of the dispenser apparatus, each medication dispenser module includes seven individually detachable medication containers (5) in which medication may be stored. These medication containers are inserted into slots (6) in a medication dispenser housing (7) with a sensor (8) to indicate the presence or absence of a medication container in a slot. A medication container (9) each has a lid (10) that opens to permit loading of medications when a medication container is inserted in a medication dispenser housing (11) and unloading of medications only when the medication container is withdrawn from the medication dispenser housing.

In the preferred embodiment of the dispenser apparatus, each medication dispenser module includes controls for setting the time when medication should be taken according to a medication therapy. A dial may be used to indicate the hour (12) and a switch (13) may be used to indicate morning (AM) or afternoon or evening (PM).

In the preferred embodiment of the dispenser apparatus, each medication dispenser module has a corresponding display (14) that shows the pattern of how medication containers have been withdrawn from the medication dispenser module over time and has a corresponding time indicator (15) that indicates the current time as it correlates to the pattern of use image shown on the display. This feature creates a feedback loop in the use of the dispenser apparatus that results in collecting medication adherence data that may be used as a metric to measure adherence to a medication therapy and the appropriateness of a prescribed medication therapy.

While the invention has been described with reference to one preferred embodiment, it is to be clearly understood by those skilled in the art that the invention is not limited thereto. Rather, the scope of the invention is to be interpreted only in conjunction with the claims.

Having described my invention, I claim:

1. A medication dispensing apparatus that:
a. stores medication in individually removable medication containers.
b. has manually operated configuration settings to indicate when doses of medication are to be taken according to a medication therapy.
c. has sensors that measure when medication containers are withdrawn from the apparatus.
d. has displays that visually represent the patterns over time with which medication containers are withdrawn from the apparatus.

2. The apparatus of claim 1 further compromising a means for calculating and storing data representing the pattern of use of the apparatus with respect to the times when medication containers are withdrawn from the apparatus.

3. The apparatus of claim 1 further being modular in design such that the configuration of the apparatus may reflect the medication therapy of taking one or more doses of medications per day over a seven-day week.

4. The apparatus of claim 1 further including microprocessor controlled electronics and a data modem that permit remote collection of the data generated by the apparatus.
